(19) United States
(12) Patent Application Publication
(10) Pub. No.: US 2018/0005317 A1
(43) Pub. Date: Jan. 4, 2018

(54) RESPONSIVE TRANSACTIONAL STATEMENT GENERATION SYSTEMS AND METHODS

(71) Applicant: BUSINESS DATA, INC., Inglewood, CA (US)

(72) Inventors: Paul A. Holtzman, Tarzana, CA (US); Darren M. Holtzman, Woodland Hills, CA (US); Todd J. Holtzman, Calabasas, CA (US); Marcos Jurgensen, Anaheim, CA (US); Edwin G. Gil, Montebello, CA (US); Michael A. Tarr, Wildwood, MO (US); Wade A. Hought, Anaheim, CA (US); Olga Lavtar, Los Angeles, CA (US); Julian Renteria, Los Angeles, CA (US); Flavio A. dos Santos, Torrance, CA (US); Michael W. Armstrong, Lake Balboa, CA (US); Stacey Taylor, Laguna Niguel, CA (US)

(21) Appl. No.: 15/597,062

(22) Filed: May 16, 2017

Related U.S. Application Data
(63) Continuation of application No. 14/195,463, filed on Mar. 3, 2014, now abandoned.

(51) Int. Cl. G06Q 40/02; G06F 17/22; G06F 17/21; G06Q 30/02; G06F 17/30

(52) U.S. Cl. CPC G06Q 40/02; G06Q 30/0251; G06F 17/30905; G06F 17/30893; G06F 17/211; G06F 17/2264; G06F 17/2247; G06F 17/30076

(57) ABSTRACT

The field of the invention relates to systems and methods for creating on-line transactional statements, and more particularly to creating electronic transactional statements that can responsively and dynamically fit any display window size. In an embodiment, a responsive transactional statement generation system having one or more processors and a non-transitory computer-readable medium containing program instructions that cause said one or more processors to receive data files each includes data representing one or more transactional statements, parse the received data files using one or more predetermined schemas to create restructured electronic transactional statements, save the restructured electronic transactional statements and display the restructured electronic transactional statements responsively at a user device. In other embodiments, the responsive transactional statement generation system compresses the restructured electronic transactional statements, saves the restructured electronic transactional statements in a secure format, and uses predetermined quality assurance processes.

### CROSS-REFERENCE TO RELATED APPLICATIONS

This application is a continuation of U.S. patent application Ser. No. 14/195,463, filed Mar. 3, 2014, which is incorporated by reference herein in its entirety for all purposes.

### FIELD OF THE INVENTION

The field of the invention relates to systems and methods for creating electronic transactional statements, and more particularly to creating electronic transactional statements that can responsively and dynamically fit any display window size.

### BACKGROUND OF THE INVENTION

Currently, when a transactional statement, e.g., a bank financial statement, is viewed online, its formatting stays the same even when the window or display size changes. For example, after the statement has been displayed and the user resizes the display window to make the window smaller, some content of the statement will not be seen, and the display software will normally display horizontal and/or vertical scroll bars for the user to scroll in order to view the truncated content. This is very inconvenient as the user may want to view all content at the same time, on the same screen. With the proliferation of mobile devices, which have small viewing windows, financial statements have been displayed in the same inconvenient formatting.

In view of the above limitations, and with the advance and widespread use of mobile devices, there is a need for systems and methods for providing transactional statements that can responsively and dynamically fit any display window size.

### SUMMARY OF THE INVENTION

The field of the invention relates to systems and methods for creating electronic transactional statements, and more particularly to creating electronic transactional statements that can responsively and dynamically fit any display window size.

In an embodiment, a responsive transactional statement generation system having one or more processors and a non-transitory computer-readable medium containing program instructions that cause said one or more processors to receive data files each includes data representing one or more transactional statements, parse the received data files using one or more predetermined schemas to create restructured electronic transactional statements, save the restructured electronic transactional statements and display the restructured electronic transactional statements responsively at a user device. In other embodiments, the responsive transactional statement generation system compresses the restructured electronic transactional statements, saves the restructured electronic transactional statements in a secure format, and uses predetermined quality assurance processes.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features, and advantages here provided will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

In order to better appreciate how the above-recited and other advantages and objects of the inventions are obtained, a more particular description of the embodiments briefly described above will be rendered by reference to specific embodiments thereof, which are illustrated in the accompanying drawings. It should be noted that the components in the figures are not necessarily to scale, emphasis instead being placed upon illustrating the principles of the invention. Moreover, in the figures, like reference numerals designate corresponding parts throughout the different views. However, like parts do not always have like reference numerals. Moreover, all illustrations are intended to convey concepts, where relative sizes, shapes and other detailed attributes may be illustrated schematically rather than literally or precisely.

FIG. 1 is an exemplary diagram of a responsive transactional statement generation system according to an embodiment of the present invention.

FIG. 2 is an exemplary block diagram of a responsive transactional statement generation server according to an embodiment of the present invention.

FIGS. 3 and 3A are exemplary presentations of a financial statement known in the art.

FIG. 4 is an exemplary presentation of a financial statement according to an embodiment of the present invention.

FIG. 5 is another exemplary presentation of a financial statement according to an embodiment of the present invention.

FIG. 6 is another exemplary presentation of a financial statement according to an embodiment of the present invention.

FIG. 7 is another exemplary presentation of a financial statement according to an embodiment of the present invention.

FIG. 8 is an exemplary presentation of a Login page not using the responsive financial statement generation system.

FIGS. 9 and 10 are exemplary presentations of a Login page according to an embodiment of the present invention.

FIG. 11 is an exemplary presentation of a web page not using the responsive financial statement generation system.

FIG. 12 is an exemplary presentation of a web page according to an embodiment of the present invention.

FIG. 13 is another exemplary presentation of a web page not using the responsive financial statement generation system.

FIG. 14 is another exemplary presentation of web pages according to an embodiment of the present invention.

FIG. 15 is another exemplary presentation of web pages according to an embodiment of the present invention.

FIG. 16 is another exemplary presentation of web pages according to an embodiment of the present invention.

FIG. 17 is another exemplary presentation of a web page not using the responsive financial statement generation system.

FIGS. 18 and 19 are other exemplary presentations of web pages according to an embodiment of the present invention.

FIG. 20 is another exemplary presentation of a web page not using the responsive financial statement generation system.

FIGS. 21 and 22 are other exemplary presentations of web pages according to an embodiment of the present invention.

FIG. 23 is an exemplary electronic process enabling the generation of responsive transactional documents according to an embodiment of the present invention.

FIG. 24 is another exemplary electronic process enabling the generation of responsive transactional documents according to an embodiment of the present invention.

### DETAILED DESCRIPTION OF THE PREFERRED EMBODIMENTS

Although described with particular reference to certain industries and/or equipment, those with skill in the arts will recognize that the disclosed embodiments have relevance to a wide variety of areas in addition to those specific examples described below.

All references, including publications, patent applications, and patents, cited herein are hereby incorporated by reference to the same extent as if each reference were individually and specifically indicated to be incorporated by reference and were set forth in its entirety herein.

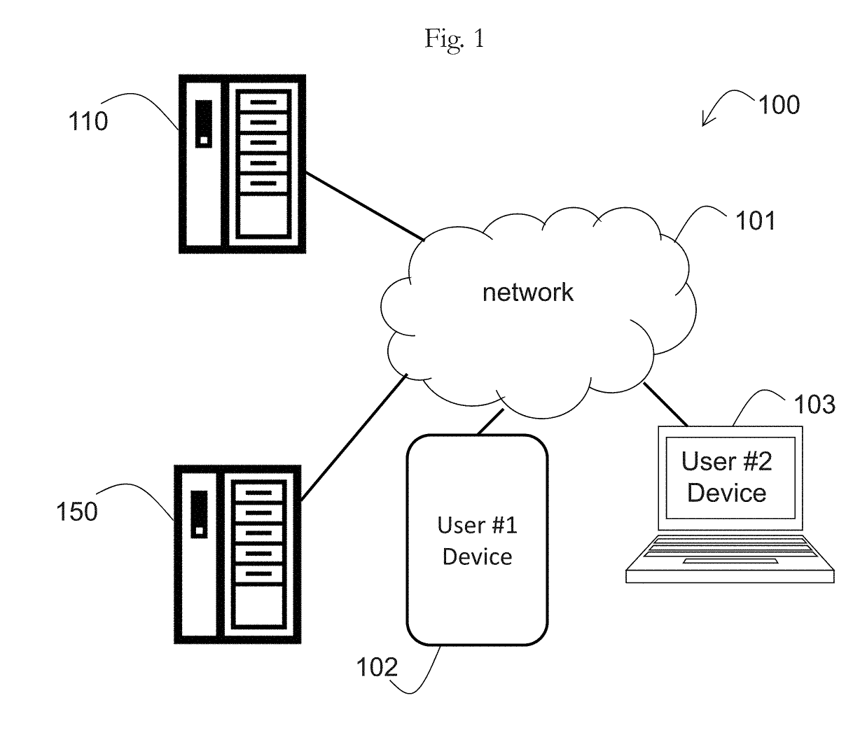

Turning to FIG. 1, according to an embodiment, a diagram of the electronic transactional statements generation system 100 architecture is shown. The system 100 generally includes a computer system 150 of an organization, e.g., a bank, credit union, insurance company, healthcare institution, other financial, commercial or non-commercial organization, etc., and a transactional statements generation server system 110, each may be distributed on one or more physical servers, may have one or more processors, memory, an operating system, and input/output interface, and a network interface all known in the art, and a plurality of end user devices 102, 103 coupled to a network 101, such as a public network (e.g., the Internet and/or a cellular-based wireless network), a private network, or a combination thereof. The user devices include, for example, mobile device 102, device 103 which may be, e.g., desktop or laptop computer, smart television, devices having a network interface known in the art, and so on. A mobile device may be a mobile phone, a tablet, a wearable device, or any portable device having a network interface known in the art. A user device 102, 103 may be any combination of devices. A user device 102, 103 may run one or more applications, such as Internet browsers, voice calls, video games, videoconferencing, and email, among others.

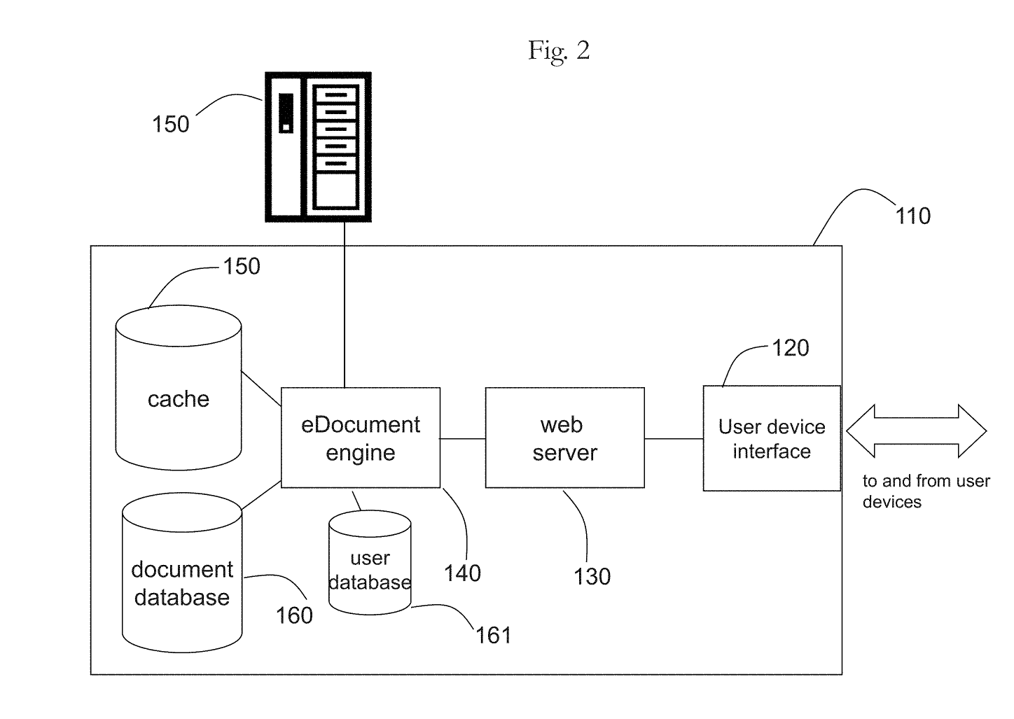

Turning to FIG. 2, according to an embodiment, a diagram of the transactional statements generation server system 110 is shown. The server 110 includes a user device interface 120 implemented with technology known in the art for communication with user devices 102, 103. The server 110 also includes communication interface implemented with technology known in the art for communication with the computer system 150 of a financial institution. The server 110 further includes an eDocument engine 140, which performs most of the document restructuring described herein, coupled to a database 160 to store transactional statements and a database 161 to store user information. The database 160, 161 may be implemented with technology known in the art, such as relational database and/or object oriented database. Moreover, the database 160, 161 may reside in a storage device which may be local and/or remote with respect to the server 110 and connected thereto via network, e.g., a local network, in a cloud network, or in an Infrastructure-as-a-Service (IaaS) configuration. The database 160 and 161 may also be combined in one physical and/or logical database. The server 110 may also include a cache server 150 and a web server 130. It will be appreciated that the server 110 may be configured in a server-client architecture, a cloud network, or a Software-as-a-Service (Saas) architecture, and so on.

The server 110 may perform certain functions in response to one or more processors executing software instructions contained in a computer-readable medium. In alternative embodiments, hardwired circuitry may be used in place of or in combination with software instructions to implement features consistent with principles of the invention. Thus, implementations consistent with principles of the invention are not limited to any specific combination of hardware circuitry and software.

A web site discussed herein may include any type of web site or web page. For example, one or more websites may be coded using hypertext markup language (“HTML”), XML, XHTML, JavaScript, Java, Perl, Visual Basic, Hypertext Preprocessor scripts (“PHP”), Active Server Page scripts (“ASP”), Objective-C, common gate interface (“CGI”) scripts, or combinations thereof. One or more websites may include the exemplary interfaces depicted by the figures.

According to an embodiment, the server 110 provides responsive electronic transactional statements, e.g., electronic financial statements, and so on, that responsively and dynamically fit any viewing window size, in different user devices 102, 103 (also known as device compatible) and independent of the applications at the user devices 102, 103. It should be noted that the responsive electronic transactional statements of the server 110 may also be displayed responsively in an electronic mail (email). For example, the server 100 may support desktop computers having display with screen size of 960 pixels and more, tablets having screen size with width between 768 pixels and 959 pixels, small tablets and mobile in landscape mode with screen size width between 480 pixels and 767 pixels, mobile phones with maximum screen size width of 479 pixels, and so on. The server 110 provides responsive electronic transactional statements that match viewing preferences, especially for complex financial statements reported by the financial, insurance, healthcare and other commercial industries. The server 110 also provides transactional statements in PDF, PCL, Postscript, or other formats that comply with all industry regulations. In another embodiment, the server 110 further provides web pages that responsively and dynamically adjust to various viewing window sizes.

According to an embodiment, the server 110 provides transactional statements, e.g., in HTML or PDF format, that include targeted marketing. Targeted marketing is the presentation of text or graphic advertisements based on end-user demographics. Demographic information is acquired directly from or calculated from client input data. One or more targeted marketing pieces can appear within a transactional statement, in one or more positions. Targeted marketing pieces can also appear within any web page. A targeted marketing piece can be a static or animated image, and may contain personalized information, such as user's name, address, geocode, account status, financial status, credit-approval status, account activity history, relationship awards, and so on. A targeted marketing piece is usually first presented in a smaller form (also known as eye-catcher) that will display the full piece when touched or clicked.

Targeted marketing pieces may be communicated globally to all users or to selected users only. Communication to selected users is commonly referred to as Targeted or TransPromo Marketing. Such marketing is based on criteria and/or instructions provided, for example, by the clients of the server 110 via computer system 150. Provision for data interrogation and analytics exists within the service of the server 110 and is performed upon client request, based on qualifying criteria within the data files provided by the client. The fullest extension of this service includes programmable support to apply rules and calculations in order to qualify certain users for eligibility to receive unique offer(s).

Users entering services and platforms supported by the server 110 may be directed to a landing page or web page that displays marketing offers or advisories in the following forms: images (e.g., JPEG, GIF, PNG, animation or similar), hyperlinks, or form appropriate to the technology extant at the time (e.g., “touch-sensitive” links that are integral to long-term efficacy and compatibility with the ongoing evolution of handheld and other devices), and so on. An image may include a hyperlink which will direct a user to a richer communication space which could be a client site, or a page or object hosted by the server 110. The size and method of presenting marketing pieces are flexible and are postulated to make the best presentation possible per the user device 102, 103.

In an embodiment, the server 110 supports any screen size through the use of the World Wide Web Consortium's (W3C) Cascading Style Sheets (CSS), e.g., CSS3 and later version. For example, CSS3 media queries can be used.

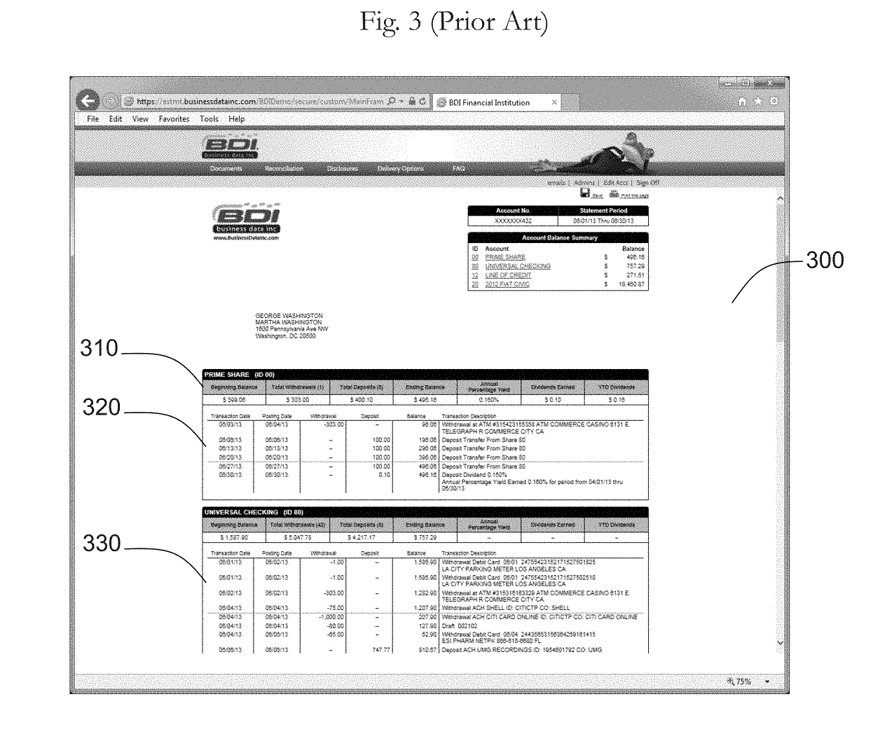

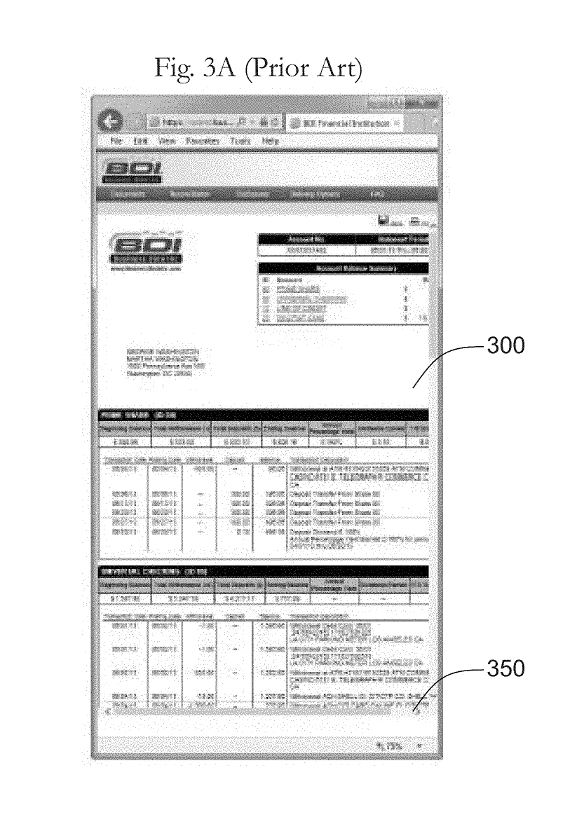

Turning to FIG. 3, an exemplary financial statement 300 known in the art is shown displayed (not using the server 110) in a wide screen. FIG. 3A shows how the financial statement 300 is currently displayed (not using the server 110) in a smaller screen, e.g., on a mobile device. It is noted that when the screen size has shrunk, the content and its formatting have remained exactly the same. Also, the browser horizontal scrollbar 350 has appeared and some content on the far right side has been truncated from the view. This design fills the available screen width (bounded by a maximum width) and makes no visual or structural changes to the content regardless of screen size.

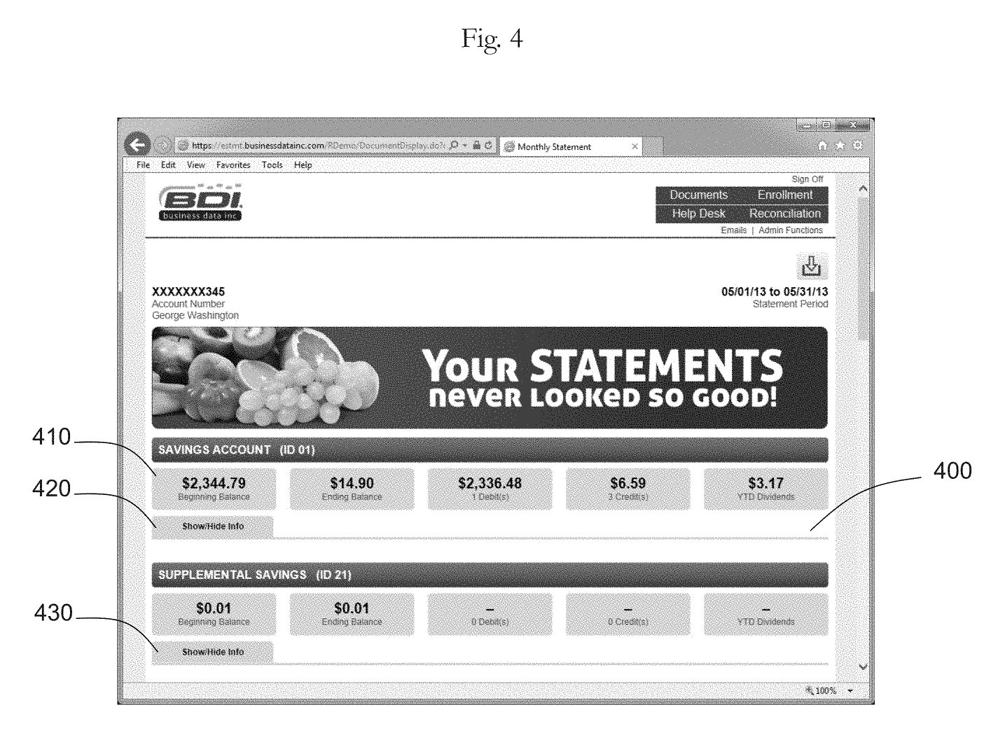

Turning to FIGS. 4 to 7, according to an embodiment, an exemplary responsive financial statement 400 is shown displayed using the server 110. As shown, the server 110 restructures the content and layout of the financial statement 400. The font size and family are optimized for readability on any display size. All data items are stackable. On a larger screen, related items can appear in a single row; when on smaller screens, these items are stacked. Color is used to identify item characteristics, eliminating space-consuming column headers on smaller screens. The ability to hide or show details support quicker user navigation. The restructure can be different for different institutions, e.g., a first bank may have different content layout and/or color scheme than those of a second bank.

According to an embodiment, the restructure may be performed off-line, and/or in batch mode. In another embodiment, the restructure may be performed in real-time.

According to an embodiment, the server 110 provides restructuring tools for a designer or administrator to perform the restructuring. In another embodiment, the server 110 performs automatic restructuring using predetermined restructuring algorithm.

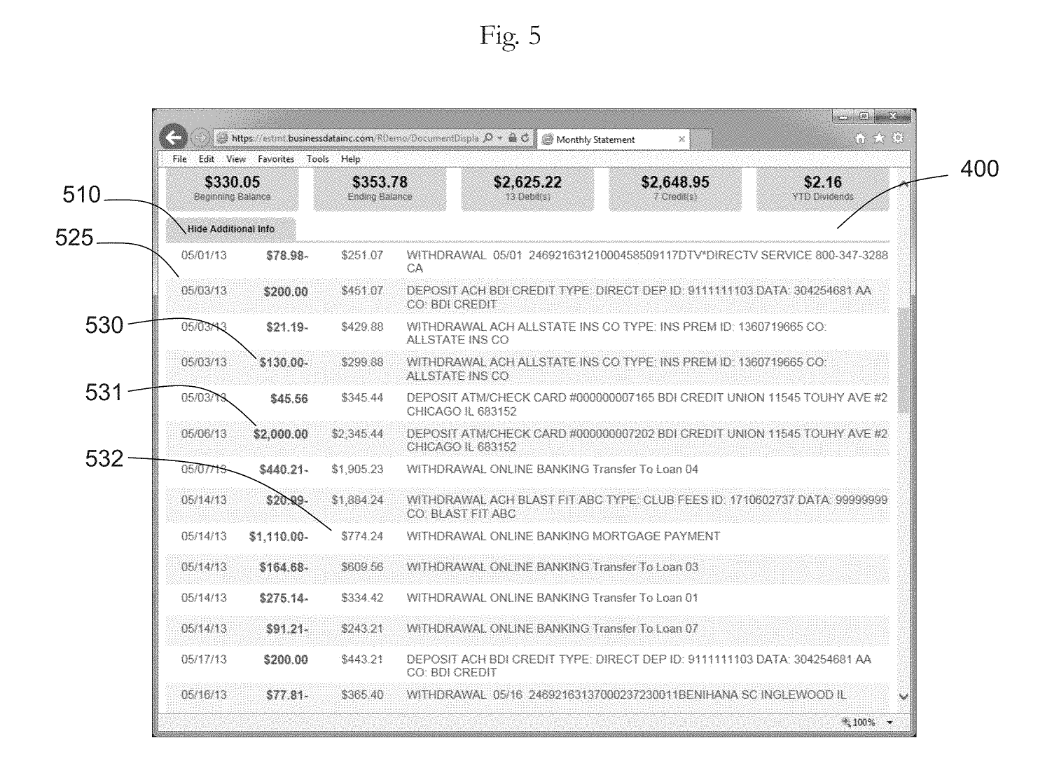

In FIG. 4, for example, the header 410 is restructured using fewer columns (e.g., Beginning Balance, Ending Balance, Debit(s), Credit(s) and YTD Dividends) than header 310 in FIG. 3 (e.g., Beginning Balance, Total Withdrawals, Total Deposits, Ending Balance, Annual Percentage Yield, Dividends Earned and YTD Dividends). As another example, in FIG. 3, financial transaction details 320, 330 are always displayed. In the financial statement 400 in FIG. 4, the financial transaction details are not displayed. As a result, Action tabs 420, 430 (e.g., Show/Hide Info) are provided to display the hidden financial transaction details, as shown in financial transaction details 525 in FIG. 5. The user may collapse (hide) the financial transaction details 525 using the Action tab 510 (e.g., Hide Additional Info).

As yet another example, in FIG. 5, the server 110 uses a color scheme to improve readability. For example, Withdrawals 530 are displayed in red while Deposits 531 are displayed in green and Balance 532 is displayed in grey.

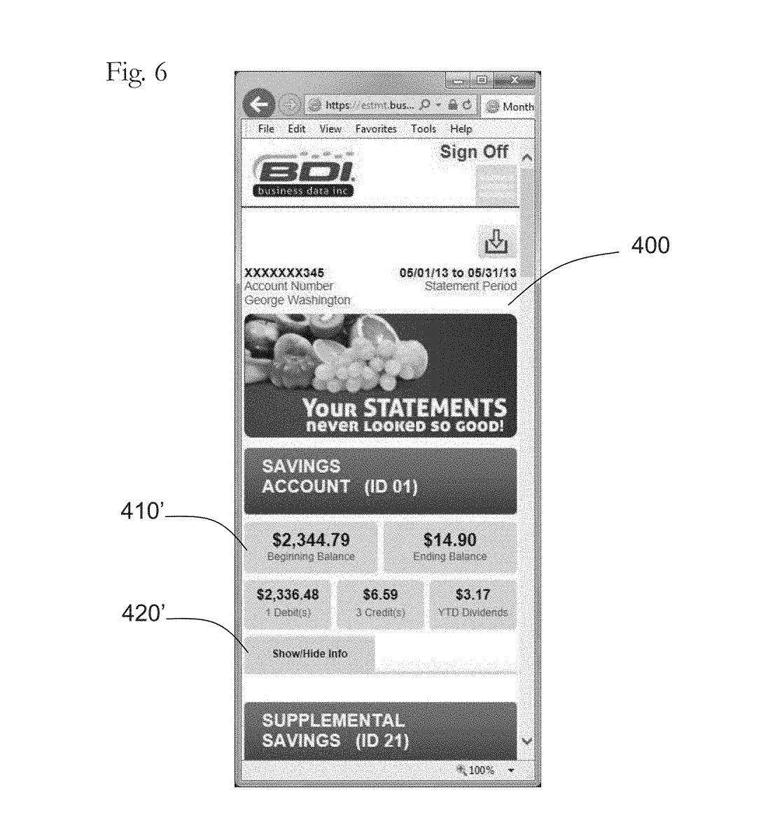

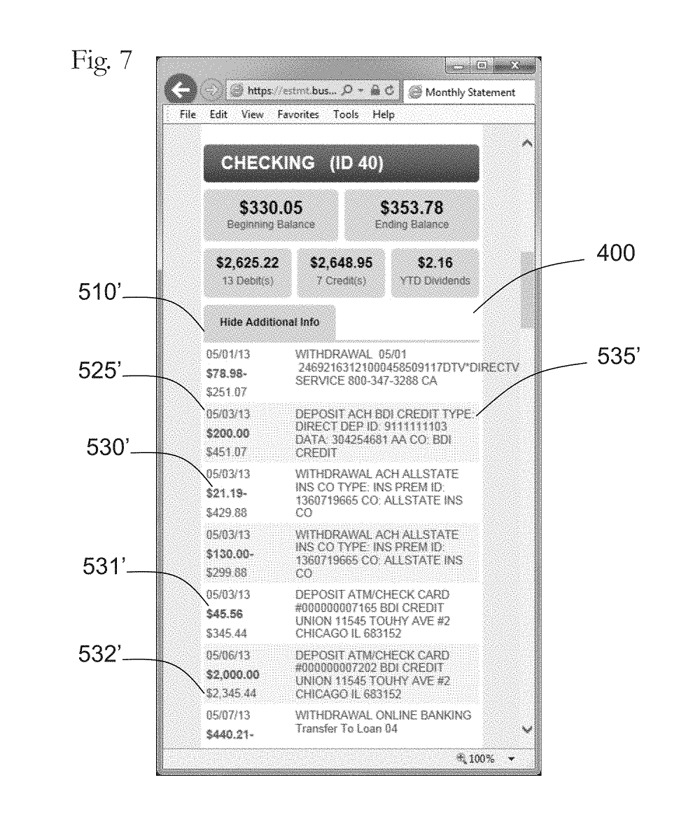

In FIG. 6, the responsive financial statement 400 is shown displayed on a smaller display or window (e.g., a mobile phone) than that of FIG. 4. Header 410′ is stacked in two rows (layers) to responsively fit the smaller width of the smaller display. It is noted that the server 110 does not make use of horizontal scroll bar. As with FIG. 4, the user may select Action tab 420′ in FIG. 6 to view hidden financial transaction details 525′, as shown in FIG. 7. In FIG. 7, the financial transaction details 525′ are also stackable. For example, Withdrawals 530′ or Deposits 531′ and Balance 532′ can be stacked in the same column. Transaction details 535′ can be stacked in more rows as needed.

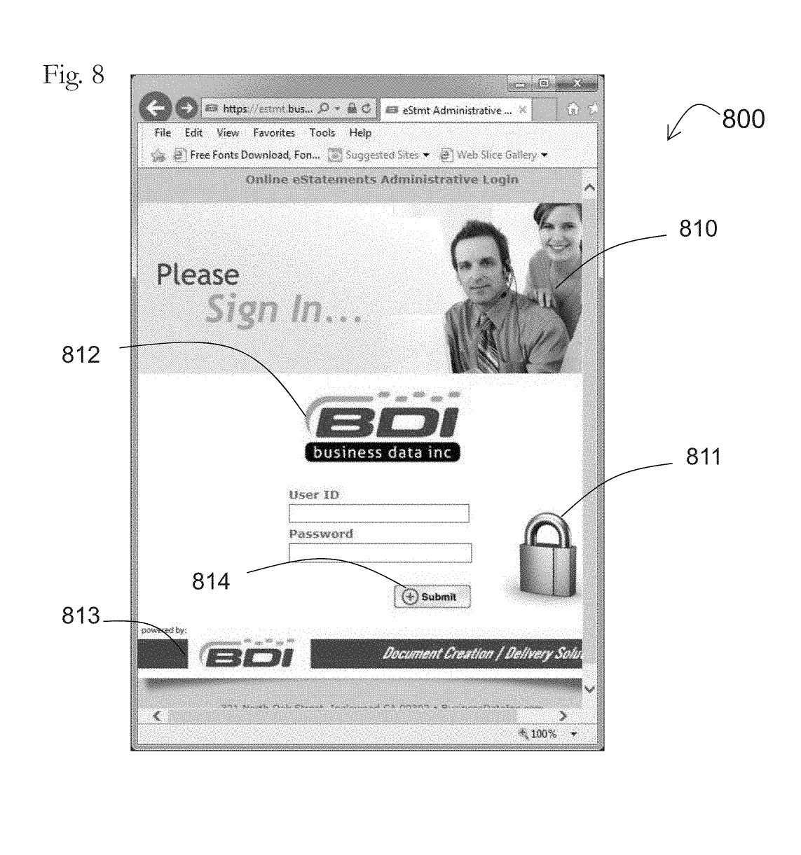

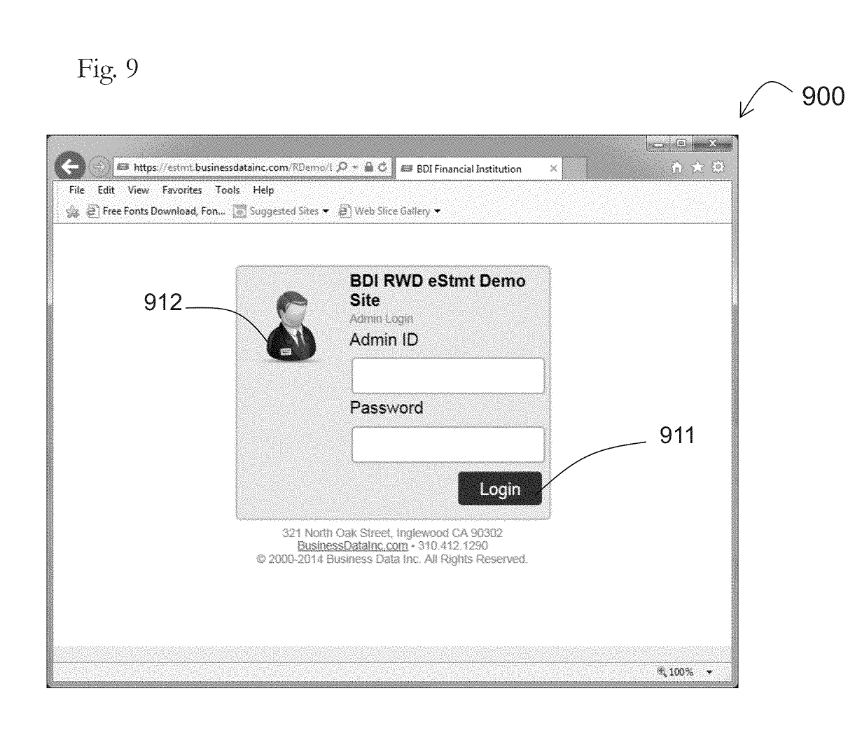

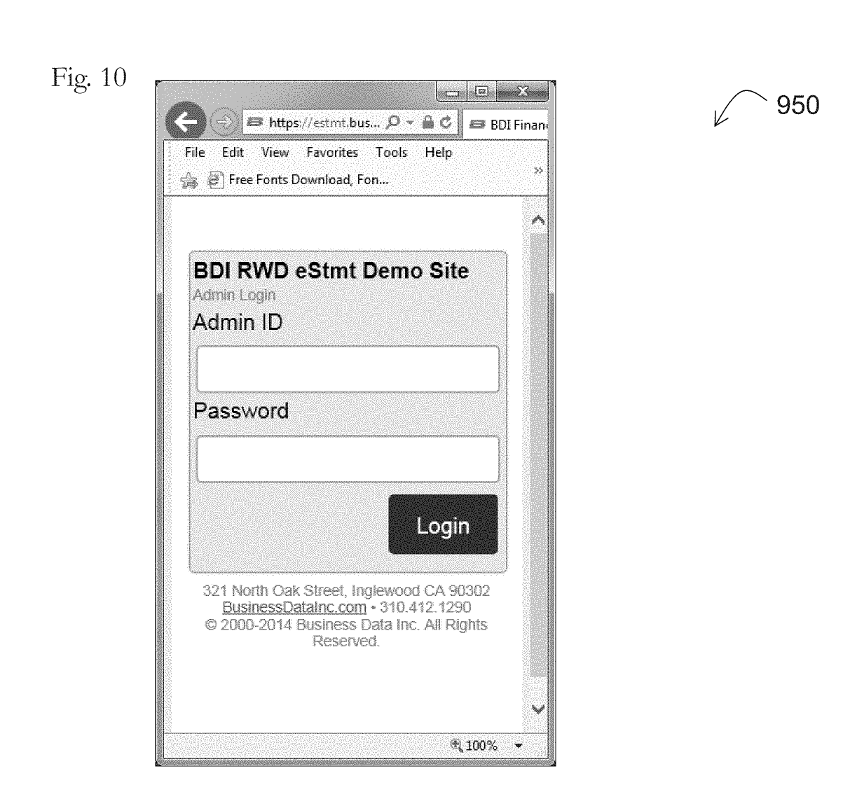

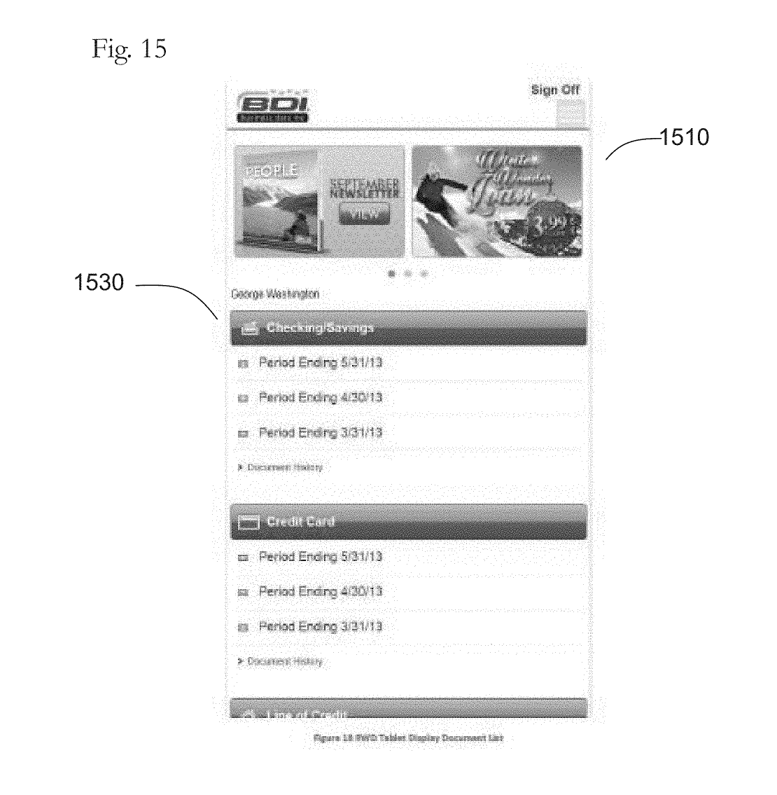

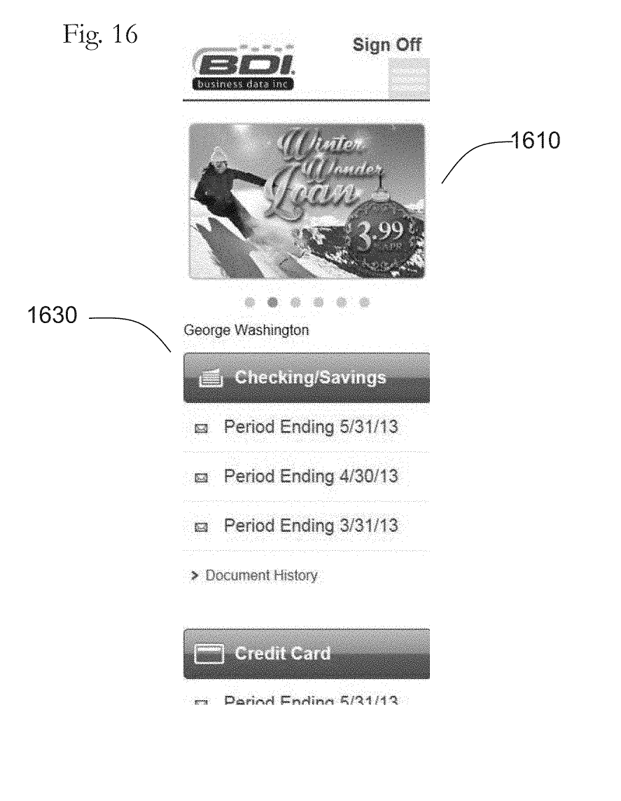

Turning to FIGS. 8 to 22, according to an embodiment, exemplary web pages restructured using the server 110 are shown. In restructuring web pages, the server 110 generally removes any generic header image at the top of the page. The placement of such image is not appropriate for a responsive web design such as that of the server 110. Smaller screens require placement of important actionable items first, followed by lesser important items. For example, for the Login web page 800 shown in FIG. 8, the server 110 removes the header image 810 and replaces it with an image at a different location, resulting in web page 900 as shown in FIG. 9. Other images such as rounded corners, padlock 811, and logos 812, 813 are also removed. The Submit image 814 is replaced with a text-only Login action item 911. As the web page 900 is displayed in a smaller display or viewing window, the server 110 responsively removes the icon 912 and all authentication prompts are stacked vertically, resulting in web page 950 as shown in FIG. 10.

According to an embodiment, as mobile devices no longer support Adobe Flash objects, the server 110 removes all Flash (also known as Small Web Format, SWF) objects in a restructured web page. Similarly, the server 110 removes other formats not supported in mobile devices. Web pages that use Flash objects may include billboard marketing pages, and so on. Once a web page has been restructured using the server 110, as the display screen size is resized smaller, the image in the web page is responsively resized to match the screen size.

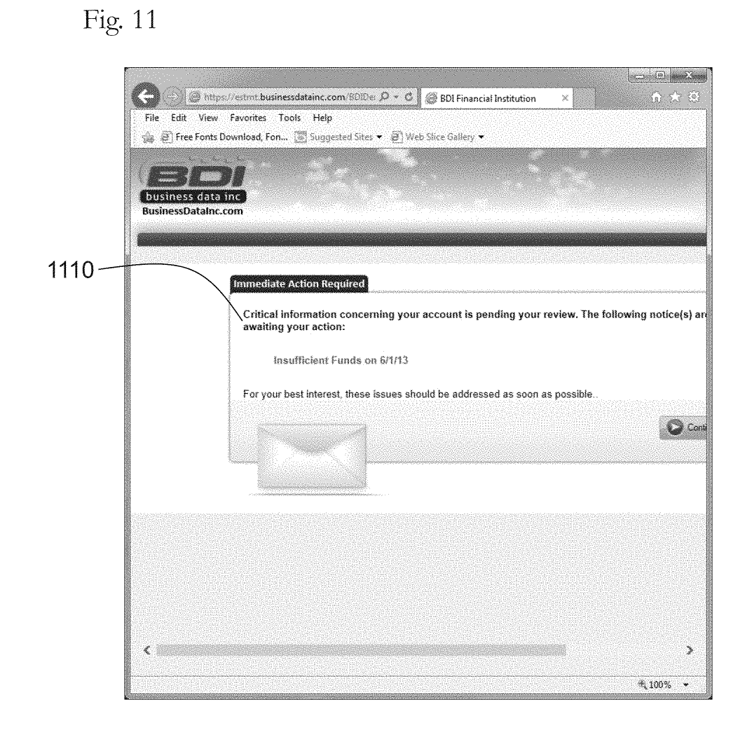

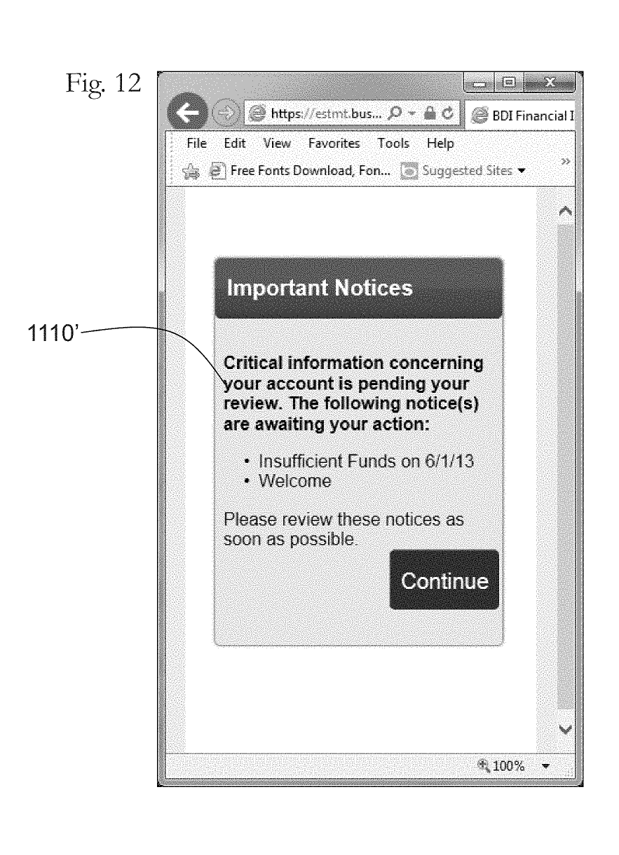

In another embodiment, as shown in FIGS. 11 and 12, the server 110 restructures text 1110 in a pre-restructured web page (FIG. 11) to wrap (text 1110′ in FIG. 12) so that each line fits in the viewable window.

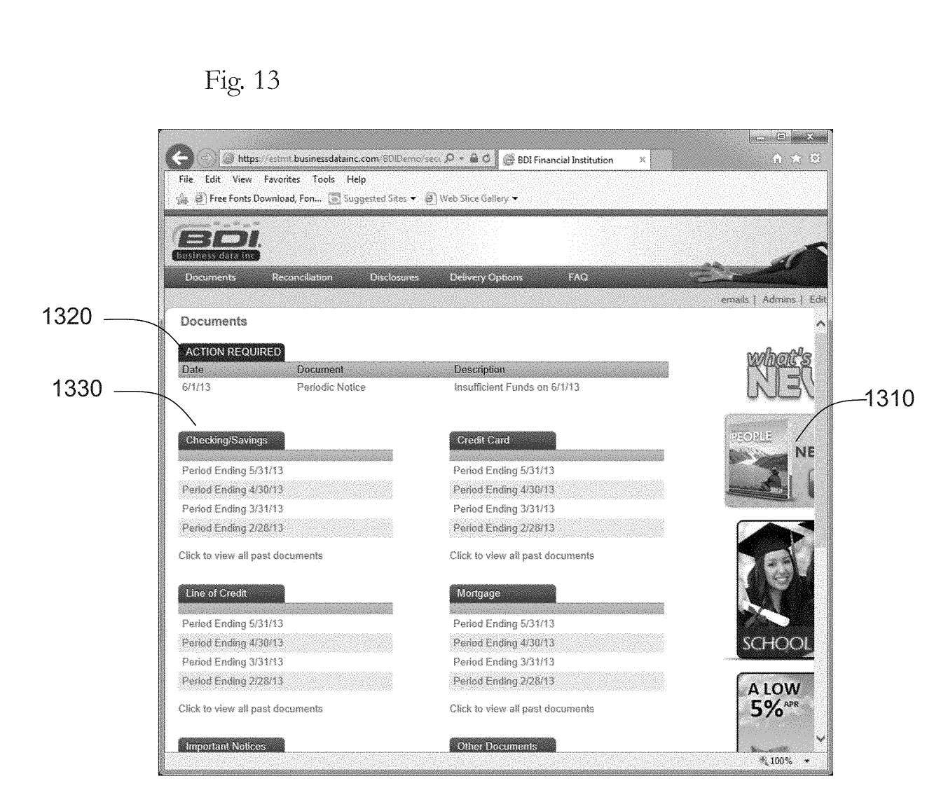

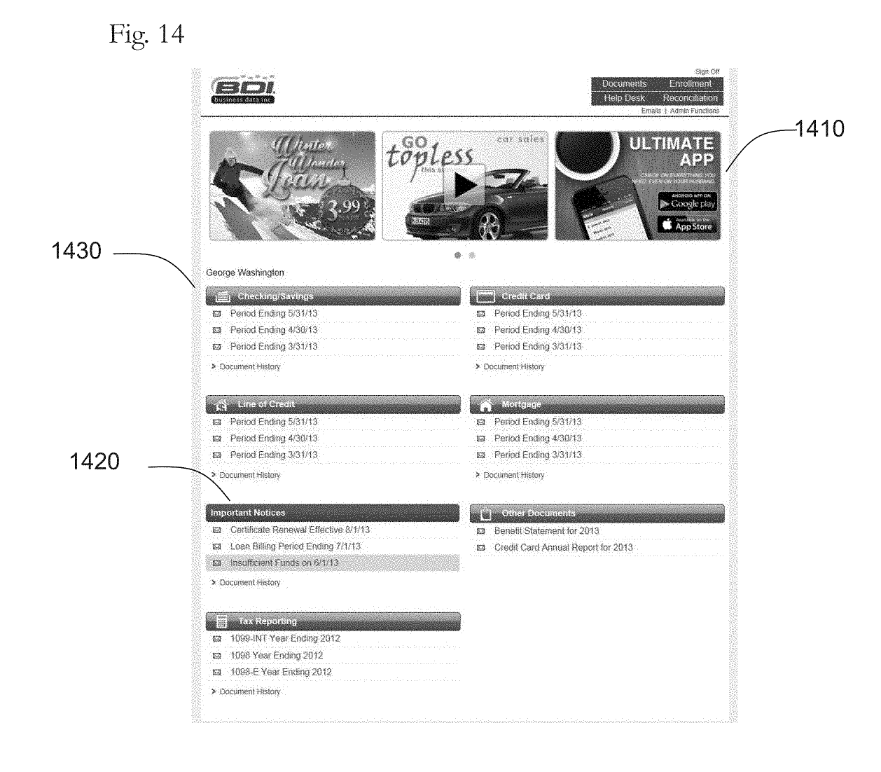

In another example, in a web page without using the server 110 (FIG. 13), certain marketing image placement is restructured from vertically stacked 1310 (e.g., on the right side) to horizontally stacked 1410 (e.g., at the top, FIG. 14). This change places the marketing messages at the most prevalent position on small devices. It also allows support for an unlimited number of marketing messages, using rotating (scrolling). The Action Required section 1320 is dropped and replaced with highlighting the document and its section header 1420. As for the Document List 1330, 1430, as the display screen sizes become smaller, the server 110 responsively reduces 2 or more column display 1330, 1430 to 1-column display 1530, 1630 as appropriate; the number of rotating marketing image 1410, 1510 responsively drops to the minimum of 1 image 1610 as appropriate; and font sizes may change, e.g., on smaller mobile devices, for easier reading.

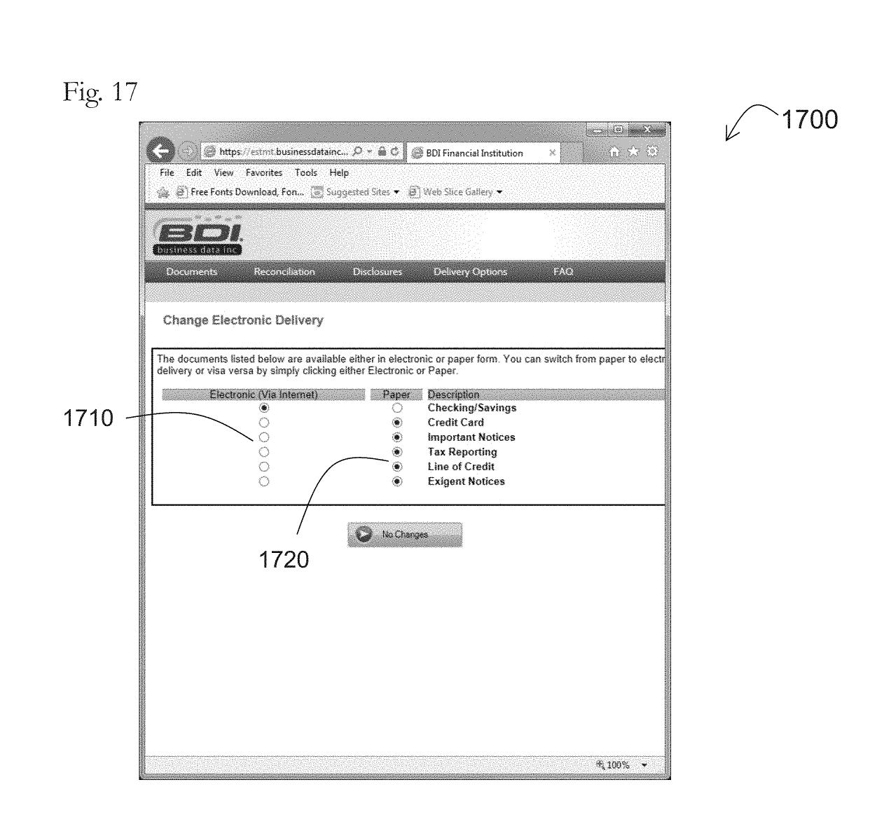

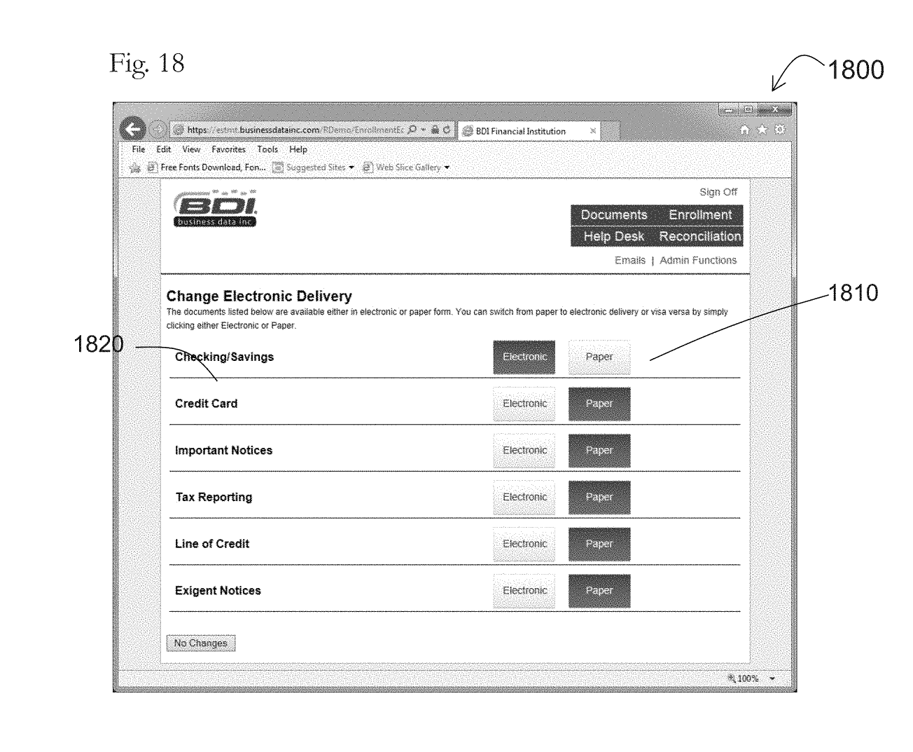

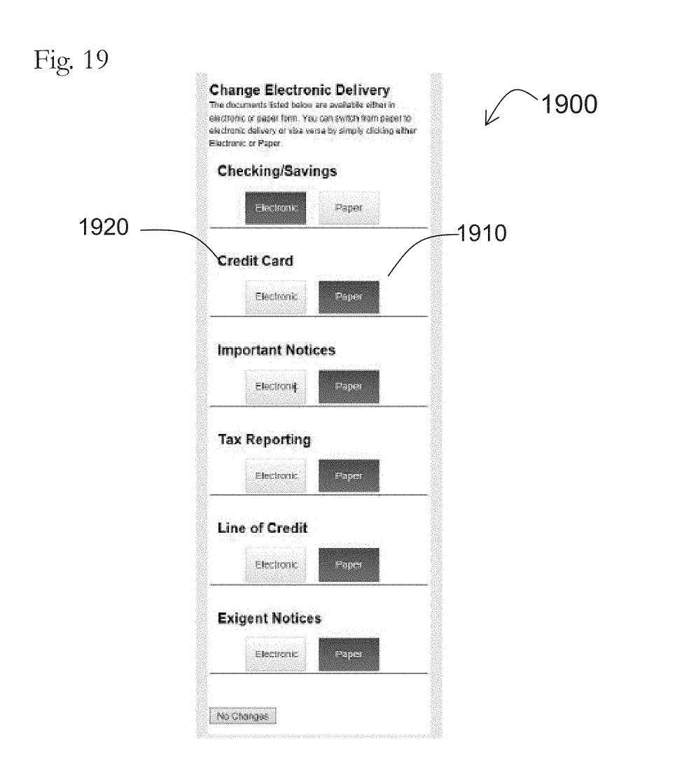

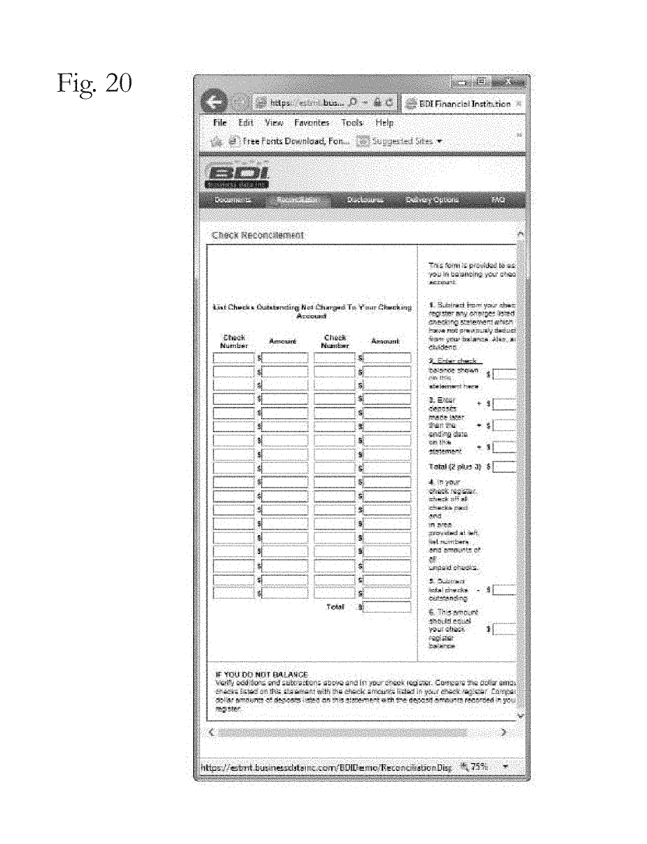

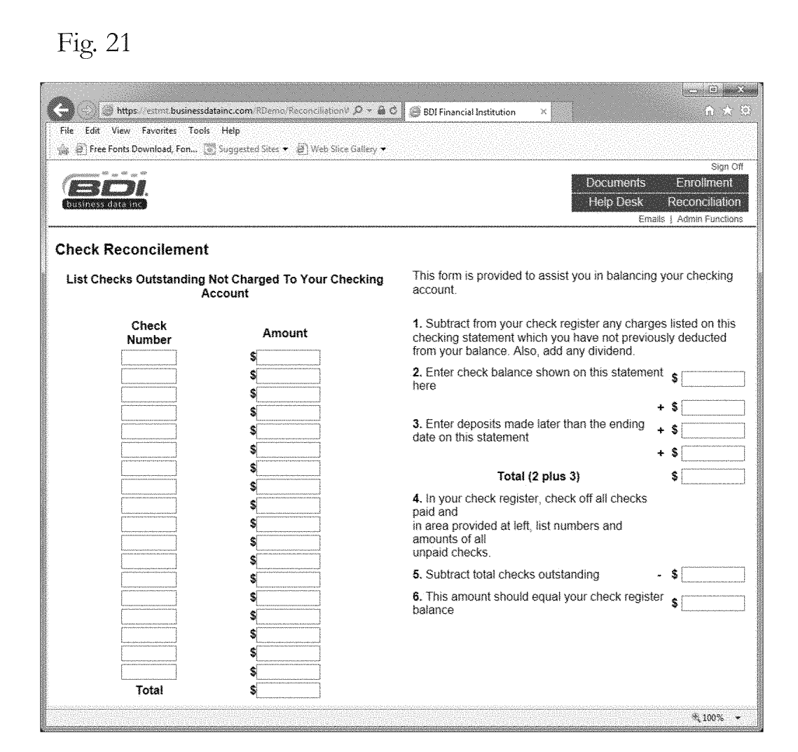

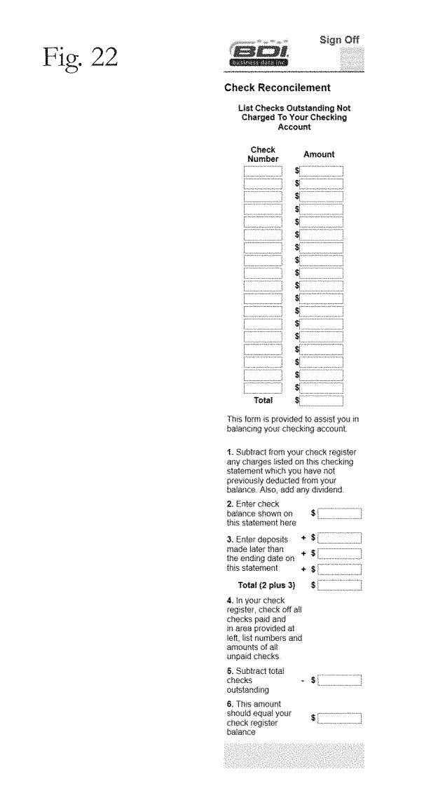

In FIGS. 17 to 19, the server 110 replaces radio buttons and other fixed layout requirements in pre-restructured web page 1700 (FIG. 17), to variable structures as shown in FIGS. 18 and 19. As the display screen is reduced in size, e.g., FIG. 18 to FIG. 19, the descriptive text 1820 can responsively be stacked with the buttons 1810, as shown in FIG. 19 with descriptive text 1920 and buttons 1910. FIGS. 20 to 22 show an exemplary restructuring of a Check Reconciliation web page from a pre-restructured page (FIG. 20), to a page restructured for a smaller display screen that can responsively resizes for, e.g., a tablet or smaller window (FIG. 21), or a mobile device (FIG. 22).

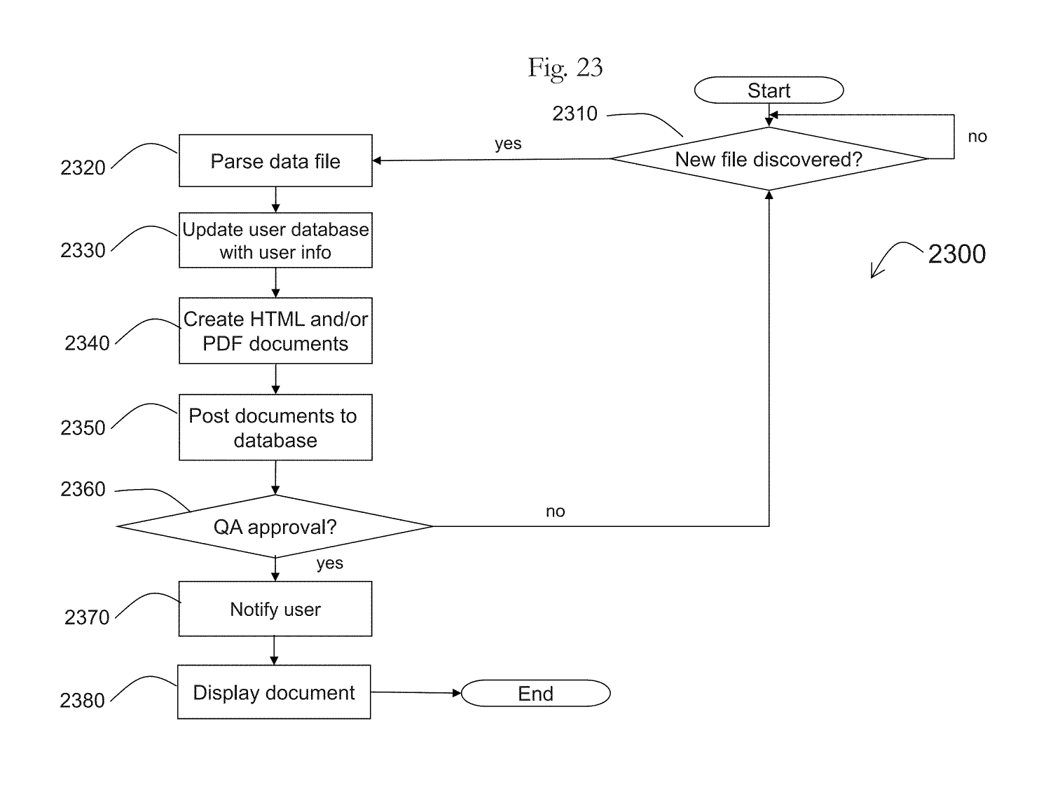

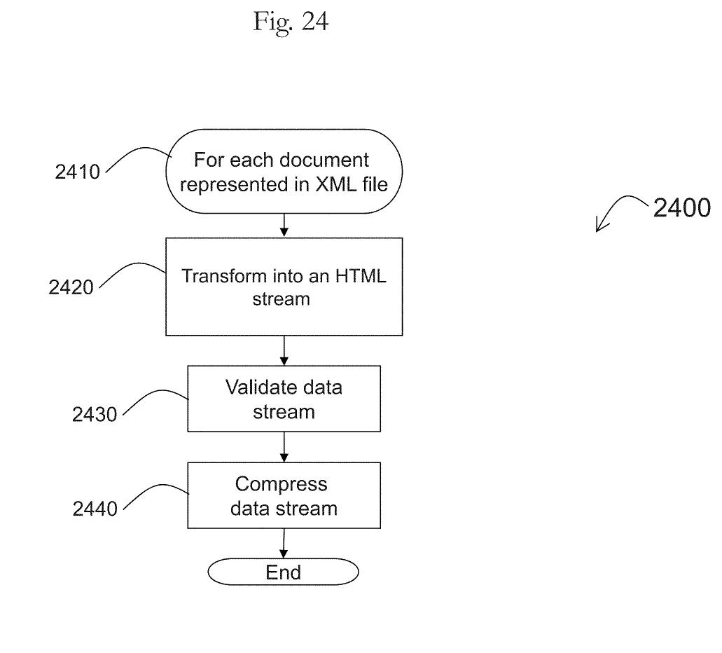

Turning to FIG. 23, according to an embodiment, a process 2300 for creating a restructured electronic transactional statement is shown. The server 110 may receive a new file, which comprises one or more documents, e.g., financial statements (Decision Block 2310), from a system 150, or from a local storage or another device. The server 110 may receive the new file through a periodic automatic file finder, in real-time, or manually. When a new file is discovered, the eDocument engine 140 (or server 110 generally) parses the data file to create an Extensible Markup Language (XML) file using a predetermined restructuring algorithm and/or schema (Action Block 2320). The server 110 may then update the user database 161 with current user information (Action Block 2330). From the XML data file, the eDocument engine 140 creates responsive HTML documents and/or documents in other formats, such as PDF, PCL, Postscript, and so on (Action Block 2340, and FIG. 24). The eDocument engine 140 then posts the documents to the document database 160 (Action Block 2350). The documents may also be stored or archived in data storage in a secure and compressed format. The server 110 then verifies the new documents with one or more predetermined Quality Assurance (QA) processes (Decision Block 2360). The QA processes may include those defined internally by the entity hosting the server 110, or by the financial institution from where the documents were received. At this time, the server 110 may notify the user whose information is included in the documents (Action Block 2370). The notification may be sent via email, text messages, and the like. When the user accesses the documents, the server 110 responsively displays the documents at the user device 102, 103.

Turning to FIG. 24, a more detailed process 2400 describing Action Block 2340 (FIG. 23) is shown. Process 2400 creates HTML and/or PDF document for each document represented in the XML data file (Action Block 2410). The eDocument engine 140 transforms the data into an HTML data stream using, for example, Java's built-in Extensible Stylesheet Language Transformations (XSLT) Application Program Interfaces (APIs) (Action Block 2420). In an embodiment, the eDocument engine 140 uses relative length units (e.g., em, percentages, and so on) and flexible property values (e.g., float, margin, padding, and so on). The eDocument engine 140 also validates the data stream to confirm that it meets HTML, e.g., HTML5, specifications (Action Block 2430). The HTML data stream will be used by the server 110 to display transactional statements, as shown in exemplary statements in FIGS. 4 to 7 above. The eDocument engine then compresses the data stream using a predetermined compression algorithm known in the art (Action Block 2440).

In addition to the above described embodiments, those skilled in the art will appreciate that this disclosure has application in a variety of arts and situations and this disclosure is intended to include the same. The described embodiments also have applications in any system that displays transactional financial statements and web pages.

Numerous specific details have been set forth to provide a thorough understanding of the embodiments. It will be understood, however, that the embodiments may be practiced without these specific details. In other instances, well-known operations, components and circuits have not been described in detail so as not to obscure the embodiments. It can be appreciated that the specific structural and functional details are representative and do not necessarily limit the scope of the embodiments.

Although some embodiments may be illustrated and described as comprising exemplary functional components or modules performing various operations, it can be appreciated that such components or modules may be implemented by one or more hardware components, software components, and/or combination thereof. The functional components and/or modules may be implemented, for example, by logic (e.g., instructions, data, and/or code) to be executed by a logic device (e.g., processor). Such logic may be stored internally or externally to a logic device on one or more types of computer-readable storage media.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of storage media include hard drives, disk drives, solid state drives, and any other tangible storage media, remote or cloud-based storage media, and so on.

It also is to be appreciated that the described embodiments illustrate exemplary implementations, and that the functional components and/or modules may be implemented in various other ways which are consistent with the described embodiments. Furthermore, the operations performed by such components or modules may be combined and/or separated for a given implementation and may be performed by a greater number or fewer number of components or modules.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a processor, or any combination thereof.

It should be noted that while this particular representation of the disclosed subject matter portrays an application integrated into a platform's website or mobile application, the disclosed subject matter is not limited to such use and can also include other mediums, including but not limited to other parties' websites, television, mobile devices, and print.

Although example diagrams to implement elements of the disclosed subject matter have been provided, one skilled in the art, using this disclosure, could develop additional hardware, software, or processes to practice the disclosed subject matter and each is intended to be included herein.

What is claimed is:

1. A responsive transactional statement generation system having one or more processors and a non-transitory computer-readable medium containing program instructions that cause said one or more processors to perform an electronic process for generating responsive electronic transactional statements, said process comprising:
receiving one or more data files each includes data representing one or more transactional statements;
parsing the one or more received data files using one or more predetermined schemas;
creating one or more restructured electronic transactional statements based on the one or more parsed data files;
saving the one or more restructured electronic transactional statements; and
displaying the one or more restructured electronic transactional statements responsively at a user device.

2. The process of claim 1, wherein the step of parsing the one or more received files using one or more predetermined schemas further creates one or more XML files.

3. The process of claim 1, wherein the step of creating one or more restructured electronic transactional statements creates one or more restructured electronic transactional statements in HTML.

4. The process of claim 1, wherein the step of creating one or more restructured electronic transactional statements creates one or more restructured electronic transactional statements in one of PDF, PCL, or Postscript.

5. The process of claim 1 further comprises compressing the one or more restructured electronic transactional statements.

6. The process of claim 1, wherein the step of saving the one or more restructured electronic transactional statements further comprises saving the one or more restructured electronic transactional statements in a secure format.

7. The process of claim 1 further comprises verifying the one or more restructured electronic transactional statements using one or more predetermined quality assurance processes.

8. The process of claim 1, wherein the step of creating one or more restructured electronic transactional statements further includes one or more targeted marketing pieces.
